(19) United States
(12) Patent Application Publication
(10) Pub. No.: US 2008/0099383 A1
(43) Pub. Date: May 1, 2008

(54) Rotatable Indicator for Spa Tub Filter Cartridge Replacement

(76) Inventors: W. John Gardenier, Wallingford, CT (US); George M. Kessler, Taftville, CT (US)

Correspondence Address: GORDON & JACOBSON, P.C., 60 LONG RIDGE ROAD, SUITE 407, STAMFORD, CT, 06902, US

(21) Appl. No.: 11/552,781

(22) Filed: Oct. 25, 2006

(51) Int. Cl. E04H 4/16; B01D 35/14

(52) U.S. Cl. 210/86; 210/167.1; 210/167.15; 210/97; 210/497.01; 210/167.18; 116/284

(57) ABSTRACT

A skimmer assembly has an upper housing and a lower housing. The lower housing contains a removable filter cartridge and the upper housing contains a floating cylindrical weir and a floating rotatable member atop the floating weir. The walls of the upper housing are curved and the water entrance includes a vertical slot which allows water to enter in a column, hit the curved wall and cause a whirlpool which causes the rotatable member to spin. The preferred embodiment includes a disposable annular filter disc removably attached to the rotatable member.

### CROSS-REFERENCE TO RELATED APPLICATIONS

This application is related to co-owned co-pending application Ser. No. 10/992,449, filed Nov. 18, 2004, entitled “Skimmer with Flexible Weir Gate for Spas and Pools”, the contents of which are hereby incorporated herein by reference.

### BACKGROUND OF THE INVENTION

1. Field of the Invention

This invention relates broadly to water filtration. More particularly, this invention relates to a skimmer having a replaceable cartridge filter and a rotating member which indicates when the cartridge needs to be replaced.

2. State of the Art

Conventional skimmers for pools and spas include a weir which is hinged at the bottom and provided with a float at the top. Behind the weir is a sump in which a filter or a basket is placed. A filter pump is coupled to the sump and draws water from the pool or spa over the weir and into the sump through the filter or basket. The floating weir assures that the pool/spa water is drawn from the surface into the sump. This causes floating waste to be drawn across the surface of the water and into the skimmer.

In skimmers which have baskets rather than filter cartridges, the owner can see waste accumulate in the basket and will know to empty the basket periodically. Skimmers which utilize replaceable filter cartridges are different. A good example of such a skimmer is shown in U.S. Pat. No. 4,637,873 issued Jan. 20, 1987 to DeSousa et al. A cylindrical filter cartridge is disposed vertically in the skimmer housing below the weir. It is difficult or impossible to determine visually whether the filter needs to be replaced. In addition, because of the way the filter cartridge is disposed in the skimmer housing, it is possible that the outer surface will become unevenly coated with waste, thereby requiring replacement more frequently than if the filter were evenly coated.

The previously incorporated related application discloses a skimmer housing having a face plate which is dimensioned to allow water to enter the housing in a vertical column. The interior of the housing has a curved wall so that when a column of water passes the face plate into the housing, a whirlpool effect is realized. A vertical filter cartridge is mounted on a rotational bearing and the whirlpool effect causes it to spin when water is being drawn into the skimmer by a pump. When the filter cartridge reaches a threshold dirt covering, water is no longer drawn through it and it stops spinning. Thus, if the owner looks inside the skimmer at the filter cartridge and sees that it is not spinning, that is an indication that it needs to be replaced. However, this requires an inspection below water level.

Another issue with spa/pool skimmer filter cartridges is oil which is present on the surface of the water. When oil enters the skimmer it tends to clog the filter cartridge and require more frequent replacement than would be the case in the absence of oil.

### SUMMARY OF THE INVENTION

It is therefore an object of the invention to provide a skimmer and filter for a pool or spa.

It is another object of the invention to provide a skimmer which uses replaceable filter cartridges.

It is a further object of the invention to provide a skimmer which provides a visual indication of when a filter cartridge needs to be replaced.

It is also an object of the invention to provide a skimmer which makes more efficient use of filter cartridges.

It is an additional object of the invention to control the amount of oil that gets to a filter cartridge.

It is still another object of the invention to provide a visual indication of when a filter cartridge needs to be replaced which is easy to see from the outside of the skimmer housing.

In accord with these objects, which will be discussed in detail below, the skimmer according to the invention includes a housing, a skimmer face plate coupled to the housing, and a flexible weir gate coupled to the face plate. When the filter pump is activated, the weir gate flexes to allow water to flow both over the top of the face plate and in a vertical column between the face plate and the housing. The interior of the housing has a curved wall so that when a column of water passes the weir gate and is pulled down into the housing, a whirlpool effect is realized.

A vertical filter cartridge is mounted in the bottom of the housing. A floating cylindrical weir assembly is mounted above the cartridge and a rotatable member (spinner) is placed above the cylindrical floating weir assembly. The inlet of a filter pump is coupled to the cartridge and also coupled to a below the surface water inlet via a check valve. When the filter is clean, water is drawn through it by the pump. When the filter reaches a threshold dirt covering, water is no longer drawn through it and the draw through the housing is decreased, causing the check valve to open to allow more water to the pump.

The spinner has a central cylindrical hub (which is centered by the floating cylindrical weir assembly) and a plurality of radially extending arms. Each of the arms terminates with upper and lower fins. When the whirlpool is created in the skimmer housing, the fins are engaged by the moving water and cause the spinner to spin. When the check valve opens, the whirlpool stops and the spinner stops spinning. According to an aspect of the invention, a replaceable annular filter disc is provided between the central hub and lower fins of the spinner. The filter disc catches oil from the surface of the water before it can reach the filter cartridge.

According to an illustrated embodiment, the weir gate flexes about a central mount and two filter cartridges are arranged side by side with a pair of floating cylindrical weirs and a pair of spinners. When the filter cartridges are clean, the spinners spin in opposite directions. Since the spinners are on the surface of the water, approximately 8-10 inches above filter cartridges, they are easy to see.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic top view of a skimmer assembly according to the invention with the pump on;

FIG. 2 is a schematic side elevation view in partial section of the skimmer assembly with the pump off;

FIG. 3 is a top plan view of a spinner according to the invention;

FIG. 4 is a section taken along line A-A in FIG. 3;

FIG. 5 is a perspective view of the spinner;

FIG. 6 is a perspective view of a filter disc according to the invention; and

FIG. 7 is a perspective view of a filter disc installed on the spinner.

### DETAILED DESCRIPTION

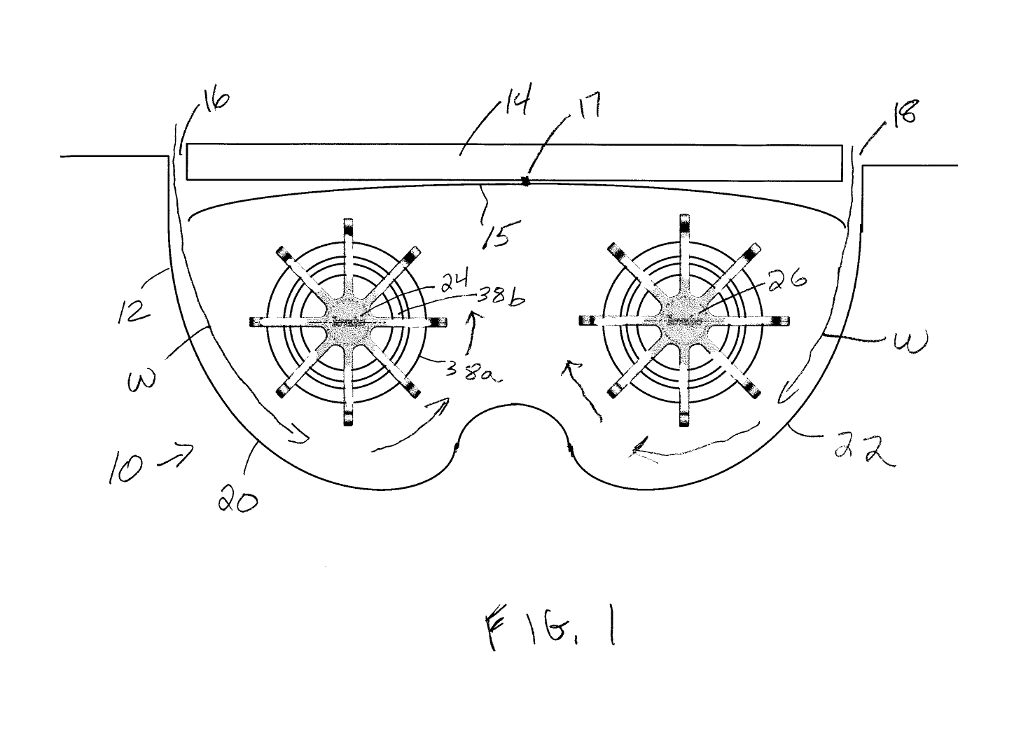

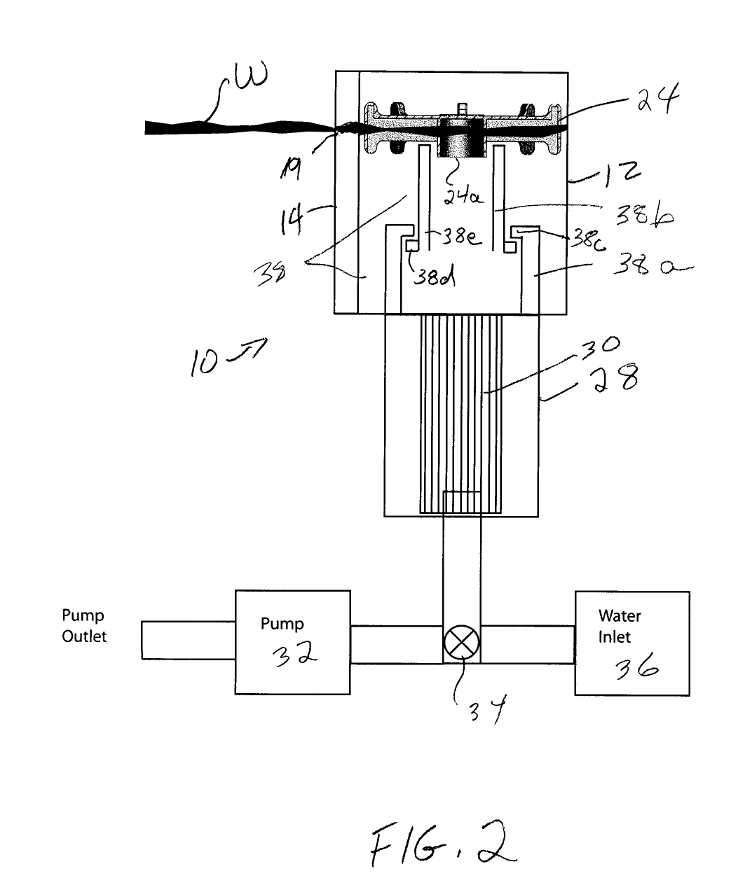

Turning now to FIGS. 1 and 2, a skimmer 10 for a spa tub or pool according to the invention includes a first housing 12 and a skimmer face plate 14 opening into the housing. The face plate 14 is dimensioned to form lateral vertical gaps 16, 18 which allow water W to flow in vertical columns between the face plate 14 and the first housing 12, and a top gap 19 over which water W can flow. According to the preferred embodiment, the face plate 14 has a flexible weir gate 15 coupled to it by fasteners 17 which are centrally located to allow the edges of the gate 15 to flex. When water passes through the gaps 16, 18, 19 between the weir gate 14 and the first housing 12, the sides and top of the weir gate 15 flex. Flexion at the top allows water to be skimmed across the surface. Flexion at the sides allows water to enter the housing 12 in columns. When the pump is deactivated, the weir gate 15 reassumes its original shape and covers the gaps 16, 18, 19 to prevent dirt within the housing 12 from escaping back into the spa tub/pool.

As seen best in FIG. 1, the interior of the first housing 12 has a pair of curved walls 20, 22 each adjacent one of the gaps 16, 18. The curved walls are arranged so that when a column of water passes through the gaps 16, 18 between the face plate 14 and the first housing 12, and over the weir gate 15, a whirlpool effect is realized. This is illustrated by the arrows in FIG. 1. As illustrated in FIG. 1, a pair of spinners 24, 26 are located in the first housing 12, each being associated with a respective curved wall 20, 22.

Referring now to FIG. 2, a second housing 28 is mounted below the first housing 12. The housing 28 includes a replaceable filter cartridge 30. Though only one cartridge 30 is seen in FIG. 2, a separate filter cartridge is provided for each spinner (24, 26 in FIG. 1), and a separate housing 28 is provided for each cartridge. The filter cartridge 30 is coupled to a pump 32 which draws water W through the filter 30 and to a pump outlet which may be above or below the surface of the water W. When the cartridge 30 reaches a threshold dirt covering, water is no longer drawn through it and a check valve 34 opens to supply water to the pump from a water inlet below the surface of the water W.

A telescoping cylindrical weir assembly 38 is mounted above the filter housing 28 in the first housing 12. A first stationary part 38a is located substantially concentric with the filter cartridge 30 and has an upper inward flange 38c. A second floating part 38b having a lower outward flange 38d is captured within the stationary part 38a but is free to move up and down, limited only by the engagement of the flanges 38c, 38d. The floating part 38b has an annular air space 38e which gives it buoyancy.

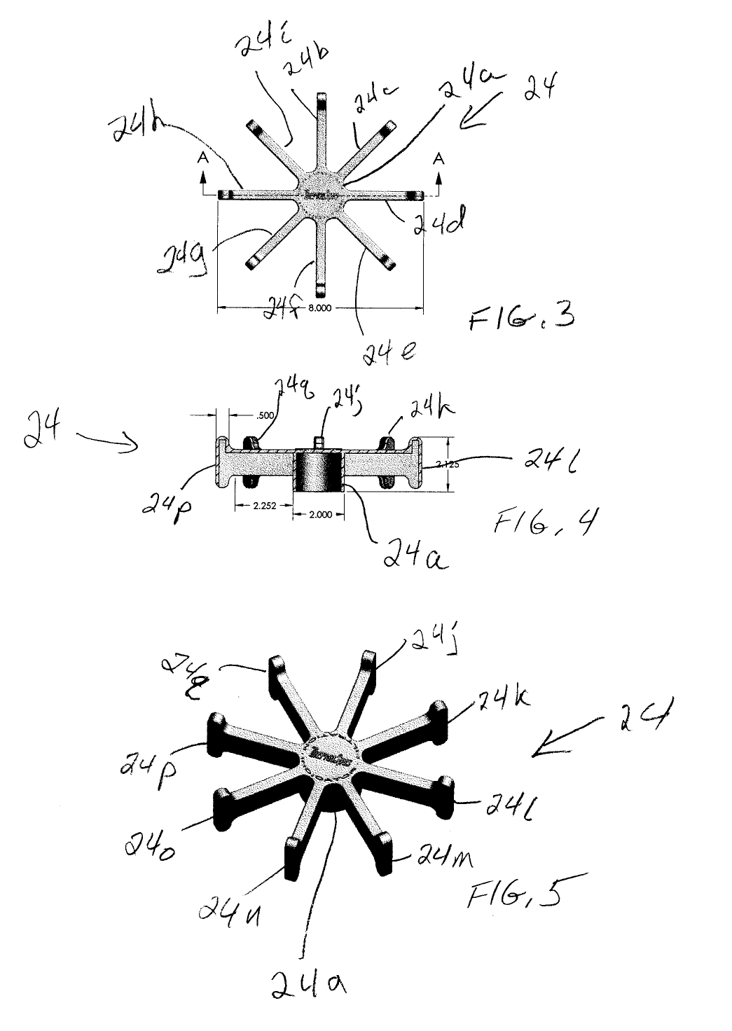

Turning now to FIGS. 3 through 5, the spinner 24 (which is identical to the spinner 26) has a central cylindrical hub 24a, and a plurality of radially extending arms 24b through 24i, each of which terminates with a pair of fins (one upper and one lower) 24j through 24q. As seen best in FIG. 4, the hub and the arms (including the fins) are hollow. This provides an air space which gives the spinner buoyancy. The presently preferred dimensions of the spinner are an overall diameter of eight inches as shown in FIG. 3 with a hub diameter of two inches as shown in FIG. 4. The fin pairs are two and one eighth inches top to bottom and one half inch inside to outside.

Referring back to FIG. 2, it can be seen that the inner hub 24a of the spinner 24 is captured inside the upper end of the floating part 38b of the cylindrical weir assembly 38 to physically reference the spinner 24 relative to the cylindrical weir assembly 38 and filter cartridge 30 below. As explained above, when the pump 32 is drawing water through the filter cartridge 30, a whirlpool is formed by the walls of the first housing 12. This causes the spinner 24 to rotate on the surface of the water. The status of the spinner can be seen by looking into the housing 12 through the opening 19. Alternatively, a window can be provided in the top of the housing 12.

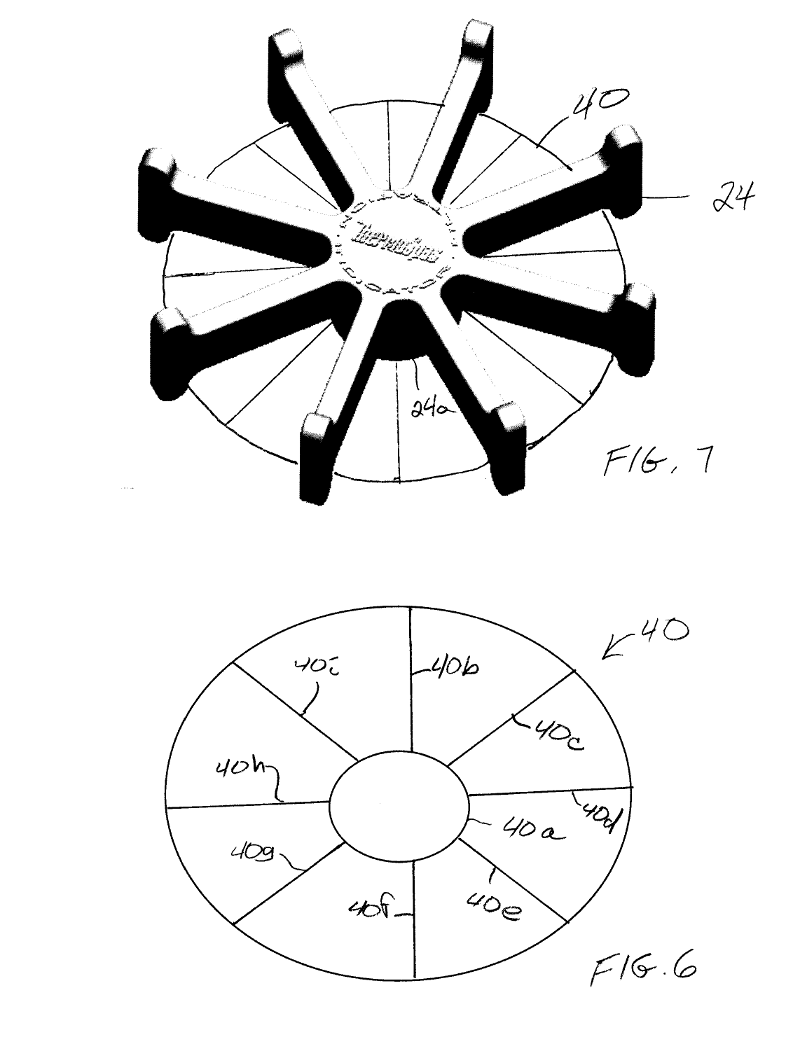

Referring now to FIGS. 6 and 7, another aspect of the invention is to provide disposable filter discs 40 for use with the spinners 24. The discs have a central hole 40a which is dimensioned to allow (snug) passage of the central hub 24a of the spinner. The overall diameter of the discs 40 is such that an annular filter space is created which extends from the hub 24a to the inside walls of the lower fins of the spinner. The disc 40 is preferably made of filter paper and also preferably provided with ribs (e.g. 40b-40i) which impart some rigidity to keep it in place when the spinner filter assembly is first placed in the skimmer and when the assembly is removed. The filter 40 prevents (or reduces) oil on the surface of the water from entering the filter cartridge.

There have been described and illustrated herein a skimmer assembly and a rotatable member for indicating when a filter cartridge needs to be replaced. While particular embodiments of the invention have been described, it is not intended that the invention be limited thereto, as it is intended that the invention be as broad in scope as the art will allow and that the specification be read likewise. Thus, while the illustrated skimmer has two filter cartridges, it will be appreciated that a skimmer with a single cartridge could be constructed incorporating the features of the invention. In a single filter embodiment, the face plate would be configured to allow only a single column of water to enter the housing. Instead of a flexible weir gate, a spring biased hinged gate could be used. It will also be appreciated that the skimmer could be assembled without a weir gate and still work, though not necessarily as well. Also while the spinner has been shown to have eight arms, a different number could be used. Furthermore, while specific dimensions have been disclosed, these dimensions are not critical. It will therefore be appreciated by those skilled in the art that yet other modifications could be made to the provided invention without deviating from its spirit and scope as claimed.

What is claimed is:

1. In a skimmer assembly for a spa tub/pool having a housing with a weir gate, the housing being shaped and the weir gate being arranged so that water entering the housing forms a whirlpool, the skimmer also having a replaceable filter cartridge which slows the flow of water through it as it accumulates dirt, the improvement comprising a filter replacement indicator,
said indicator situated over the filter cartridge and being sufficiently buoyant to float on water, and having a hub and a plurality of arms extending outward from said hub, said indicator being caused to rotate by the whirlpool when water is drawn through the filter cartridge.

2. The improvement of claim 1, wherein:
said buoyancy is provided by an air spaced defined in a portion of said indicator.

3. The improvement of claim 1, wherein:
said arms of said indicator are radially arranged about said hub.

4. The improvement of claim 1, wherein:
at least some of said arms terminate in a fin.

5. The improvement of claim 1, wherein:
each arm terminates with an upper fin and a lower fin.

6. The improvement of claim 2, wherein:
said plurality of arms is at least four arms.

7. The improvement of claim 1, further comprising:
a replaceable annular filter element, said filter element defining a central hole dimensioned to receive said hub and having an overall diameter extending substantially the length of said arms.

8. The improvement of claim 1, wherein:
said indicator is not coupled to said filter cartridge.

9. A pool/spa skimmer, comprising:
a housing;
a first member mounted relative to said housing and defining at least one lateral vertical gap between said housing and said first member;
an indicator inside said housing that is sufficiently buoyant to float on water;
a pump coupled to said housing, wherein
when said pump is activated, water enters from the pool/spa through said at least one lateral gap and into said housing causing said indicator to rotate.

10. The skimmer according to claim 9, wherein:
said indicator includes a central hub with a plurality of extending arms.

11. The skimmer according to claim 10, wherein:
said arms terminate with fins.

12. The skimmer according to claim 10, wherein:
each of said arms terminates with an upper fin and a lower fin.

13. The skimmer according claim 12, further comprising:
a replaceable annular filter, said filter defining a hole dimensioned to receive said hub and having an overall diameter extending to said lower fins.

14. The skimmer according to claim 13, wherein:
said annular filter has a plurality of radial ribs.

15. The skimmer according to claim 9, further comprising:
a cylindrical weir arranged beneath said indicator.

16. The skimmer according to claim 15, wherein:
said cylindrical weir has a stationary part and a floating part.

17. The skimmer according to claim 16, wherein:
said floating part is concentric with and slidable relative to said stationary part.

18. The skimmer according to claim 17, wherein:
said stationary part has an upper inward flange and said floating part has a lower outward flanges, said flanges cooperating to limit upward movement of said floating part.

19. The skimmer according to claim 18, wherein:
said indicator includes a substantially cylindrical hub with a plurality of radially extending arms, said hub being arranged substantially concentric with and within said floating part.

20. A filter cartridge replacement indicator for a pool or spa filter, comprising:
a buoyant structure that floats on water, said structure adapted to rotate in a whirlpool current, wherein when the whirlpool current is at a first speed through a relatively cleaner filter cartridge the structure will rotate at a faster speed and when the whirlpool current is at a second relatively slower second speed through a relatively dirtier filter cartridge the structure will rotate at a slower speed; and
means for referencing said structure over said filter cartridge.

21. An indicator according to claim 20, further comprising:
a replaceable filter element coupled to said buoyant structure.
